(19) United States
(12) Patent Application Publication
(10) Pub. No.: US 2020/0349737 A1
(43) Pub. Date: Nov. 5, 2020

(54) MULTI-TARGET CALIBRATION AND AUGMENTATION

(71) Applicant: FANUC AMERICA CORPORATION, Rochester Hills, MI (US)

(72) Inventors: Leo Keselman, Menlo Park, CA (US); Derek Jung, Clinton Township, MI (US); Kenneth W. Krause, Rochester Hills, MI (US)

(21) Appl. No.: 16/862,757

(22) Filed: Apr. 30, 2020

Related U.S. Application Data
(60) Provisional application No. 62/843,131, filed on May 3, 2019.

(51) Int. Cl. G06T 7/80; G06T 19/00; B25J 9/16

(52) U.S. Cl. CPC G06T 7/80; G06T 19/006; G06T 2207/30204; B25J 9/1666; B25J 9/1692

(57) ABSTRACT

A system and method for setting up an AR application that uses a plurality of markers so that accurate augmentations can be displayed anywhere a marker is visible. The method includes placing a plurality of markers throughout the workspace so that a plurality of pairs of two adjacent markers can be viewed in a field-of-view of an AR device. The method further includes determining a distance relationship between the two markers in all of the pairs of markers, and determining a distance relationship between all non-adjacent markers using the distance relationship between the two markers in all of the pairs of markers. The method also includes identifying a distance relationship between one of the plurality of markers and an augmentation in the workspace, and identifying a distance relationship between the other markers and the augmentation using the distance relationships between the adjacent markers and the non-adjacent markers.

### CROSS-REFERENCE TO RELATED APPLICATIONS

This application claims the benefit of the filing date of U.S. Provisional Application 62/843,131, titled Multi-Target Calibration and Augmentation, filed May 3, 2019.

### BACKGROUND

### Field

This disclosure relates generally to a system and method for setting up an augmented reality (AR) application that uses a plurality of markers and, more particularly, to a system and method for setting up an AR application that uses a plurality of markers provided throughout a workspace so that accurate augmentations can be displayed anywhere a marker is visible.

### Discussion

Augmented reality (AR) has been described as an interactive experience of a real-world environment where objects that reside in the real-world are enhanced by computer-generated perceptual information in the virtual world. The use of AR systems for simulating the operation of industrial robots for calibration purposes, teaching purposes, etc. is known in the art. An AR system can be used, for example, in teaching a robot how to perform a certain operation, where a skilled operator uses the AR system to demonstrate the operation and the robot learns the motions involved. The AR system can also be used for other teaching activities, such as establishment of virtual safety zones into which the robot must not encroach.

In one known AR system, augmentations are displayed relative to a single fixed target. For the best accuracy, the target should be visible in the field-of-view of the AR device, which limits the area where a user can be to see the most accurate augmentation. Motion tracking can be used to display augmentations when the marker is not in view, however accuracy degrades quickly.

### SUMMARY

The following discussion discloses and describes a system and method for setting up an AR application that uses a plurality of markers so that accurate augmentations can be displayed anywhere a marker is visible. The method includes placing the plurality of markers throughout the workspace so that a plurality of pairs of two adjacent markers can be viewed in a field-of-view of an AR device. The method further includes determining a distance relationship between the two markers in all of the pairs of markers, and determining a distance relationship between all pairs of non-adjacent markers using the distance relationship between the two markers in all of the pairs of markers. The method also includes identifying a distance relationship between one of the plurality of markers and an augmentation in the workspace, and identifying a distance relationship between the other markers and the augmentation using the distance relationships between the adjacent markers and the non-adjacent markers. In one embodiment, the workspace includes a robot and the augmentation is a point on the robot.

Additional features of the disclosure will become apparent from the following description and appended claims, taken in conjunction with the accompanying drawings.

### BRIEF DESCRIPTION OF THE DRAWINGS

FIG. 1 is an isometric view of a work station including a robot and plurality of stationary markers; and

FIG. 2 is a flow chart diagram showing a process for setting up an AR application.

### DETAILED DESCRIPTION OF THE EMBODIMENTS

The following discussion of the embodiments of the disclosure directed to a system and method for setting up an augmented reality application using a plurality of markers is merely exemplary in nature, and is in no way intended to limit the disclosure or its applications or uses.

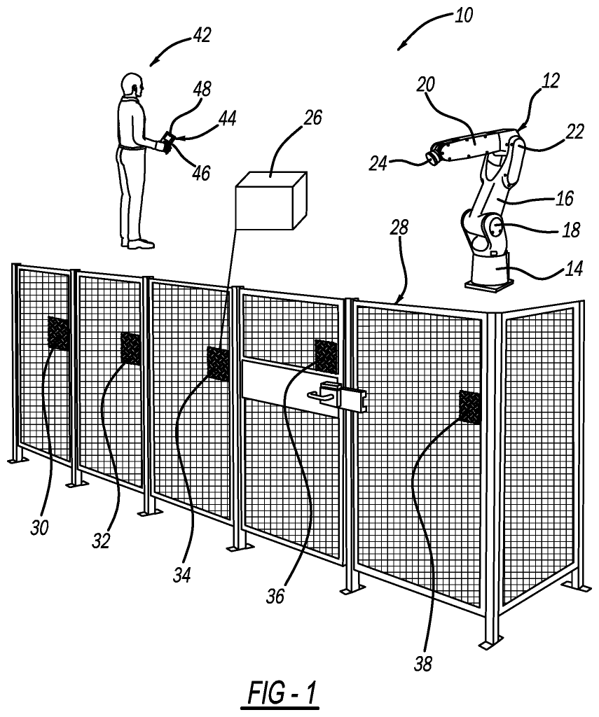

FIG. 1 is an isometric view of a work station 10 including a machine, specifically a robot 12 having a base portion 14, an extension link 16 coupled to the base portion 14 by a rotary and pivot joint 18, a working link 20 coupled to the extension link 16 opposite to the base portion 14 by an elbow pivot joint 22 and an end-effector 24. The robot 12 can be any multi-axis industrial robot suitable for the purposes discussed herein, such as a six-axis robot, that can be programmed to perform a variety of operations in a manufacturing environment, such as material cutting, welding, part selection/movement/placement, painting, etc. It is noted that the robot 12, or any other machine, is shown merely to give context to the work station 10.

A security fence 28 is provided at the work station 10 and is positioned around the robot 12 for safety purposes and operates in this discussion as a non-moving component separated from the robot 12. A plurality of unique stationary augmented reality markers 30, 32, 34, 36 and 38, such as an image, model or other indicia, having a number of recognizable features, where the features on the markers 30, 32, 34, 36 and 38 are different from each other, are secured to the fence 28. It is noted that the markers 30, 32, 34, 36 and 38 can be provided on any suitable stationary object in the work station 10 other than the fence 28. It is further noted that providing five markers is merely an example, where any number of suitable markers can be provided. A user 42 is standing in the work station 10 and is holding a tablet 44 on which has been downloaded an AR application, where the tablet 44 has a camera 46 that takes images of the work station 10 that are provided to the AR application and a display 48 that displays the work station 10 including the location of the markers 30, 32, 34, 36 and 38, and other things. The markers 30, 32, 34, 36 and 38 are positioned on the fence 28 so that any two adjacent markers 30, 32, 34, 36 or 38 are visible in one single camera view. Specifically, the markers 30, 32, 34, 36 and 38 are arranged on the fence 28 so that all of the adjacent groups of any two markers, such as the markers 30 and 32, the markers 32 and 34, the markers 34 and 36, and the markers 36 and 38 are visible in one camera view. Other AR devices, such as AR glasses, a smartphone, etc., other than the tablet 44 can also be employed.

As will be discussed in detail below, this disclosure describes an AR process and image recognition algorithm where an augmentation in the work station 10, shown here as box 26, for example, a point on the robot 12, is displayed on the tablet 44 in relationship to the markers 30, 32, 34, 36 and 38. The process includes a calibration step that systematically locates each set of two adjacent markers 30, 32, 34, 36 and 38 in the view of the camera 46 at a time for calibrating the position of the markers 30, 32, 34, 36 and 38 in the work station 10 to determine a distance relationship between the adjacent markers. For example, the camera 46 will be controlled to first place the markers 30 and 32 in the camera view so that the algorithm establishes a distance relationship between the markers 30 and 32, then place the markers 32 and 34 in the camera view so that the algorithm establishes a distance relationship between the markers 32 and 34, then place the markers 34 and 36 in the camera view so that the algorithm establishes a distance relationship between the markers 34 and 36, and then place the markers 36 and 38 in the camera view so that the algorithm establishes a distance relationship between the markers 36 and 38. Thus, unless the first two markers 30 and 32 are being viewed, at least one of the markers 32, 34, 36 or 38 should have already been identified in a previous calibration step. This calibration process continues until the location of all of the markers 30, 32, 34, 36 and 38 have been determined.

The distance values determined by the image recognition algorithm between all of the adjacent markers, i.e., the markers 30 and 32, the markers 32 and 34, the markers 34 and 36 and the markers 36 and 38, are shown in Table 1 below, where M refers to a marker, T identifies a distance transform from one marker to another marker, the reference number identifies the particular marker 30, 32, 34, 36 and 38, columns are the distance transform from a marker and the rows are the distance transform to a marker. The distance relationship between any two markers 30, 32, 34, 36 and 38 that are not adjacent to each other are mathematically calculated from the known distance relationships between the adjacent markers as multiplications between the distance transform from one marker to an adjacent marker as shown in Table 1.

TABLE 1

| | M30 | M32 | M34 | M36 | M38 |
|---|---|---|---|---|---|
| M30 | \| | T32-30 | T34-32*T32-30 | T36-34*T34- | T38-36*T36- |
| | | | | 32*T32-30 | 34*T34- |
| | | | | | 32*T32-30 |
| M32 | T30-32 | \| | T34-32 | T36-34*T34-32 | T38-36*T36- |
| | | | | | 34*T34-32 |
| M34 | T30-32*T32-34 | T32-34 | \| | T36-34 | T38-36*T36-34 |
| M36 | T30-32*T32- | T32-34*T34-36 | T34-36 | \| | T38-36 |
| | 34*T34-36 | | | | |
| M38 | T30-32*T32- | T32-34*T34- | T34-36*T36-38 | T36-38 | \| |
| | 34*T34- | 36*T36-38 | | | |
| | 36*T36-38 | | | | |

Once all of the possible distance relationships between the markers 30, 32, 34, 36 and 38 have been established, an application runtime operation can be performed to determine the relationship between the augmentation box 26 and each of the markers 30, 32, 34, 36 and 38. The AR algorithm first determines the distance relationship between one the markers 30, 32, 34, 36 or 38 and the augmentation box 26, for example, the closest one of the markers 30, 32, 34, 36 or 38 to the augmentation box 26, using a previously determined technique at any point during operation of the application. The algorithm then uses the transforms from Table 1 to determine the distance relationship between the augmentation box 26 and the other markers 30, 32, 34, 36 or 38. For example, the algorithm calculates offsets of the displayed augmentation using the offset relative to the registered marker modified by the offset of the currently visible marker to the registered marker. As the user 42 moves around to different locations, the augmentation box 26 is displayed relative to the marker 30, 32, 34, 36 or 38 whose location has the most confidence at that location.

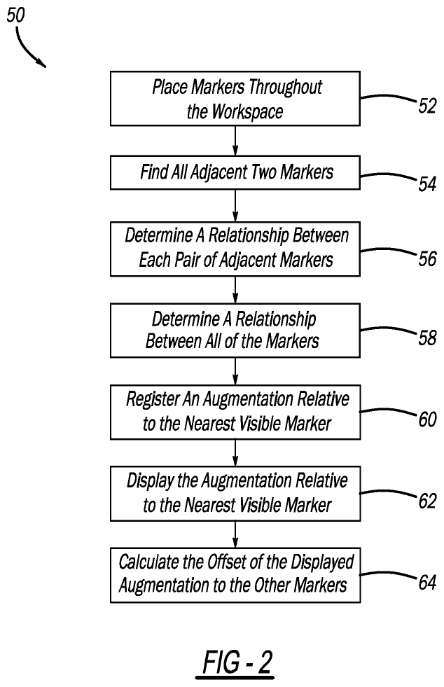

FIG. 2 is a flow chart diagram 50 showing a process for establishing an AR application as described above. The markers 30, 32, 34, 36 and 38 are placed throughout the work station 10 at box 52. The user 42 finds each pair of adjacent markers in the camera view at box 54. The algorithm determines a distance relationship between the pairs of adjacent markers 30, 32, 34, 36 and 38 at box 56. The algorithm determines a distance relationship between all of the markers 30, 32, 34, 36 and 38 at box 58. The algorithm registers an augmentation in the work station 10 to one of the markers 30, 32, 34, 36 and 38 at box 60. The algorithm displays the augmentation relative to the nearest marker at box 62. The algorithm calculates offsets between the displayed augmentation and the other markers at box 64.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for providing an augmented reality (AR) application, said method comprising:
placing a plurality of markers throughout a workspace so that a plurality of pairs of two adjacent markers can be viewed in a field-of-view of an AR device having a camera;
determining a distance relationship between the two adjacent markers in all of the pairs of markers;
determining a distance relationship between all pairs of non-adjacent markers using the distance relationship between the two markers in all of the pairs of markers;
identifying a distance relationship between one of the plurality of markers and an augmentation in the workspace; and
identifying a distance relationship between all of the other plurality of markers and the augmentation using the distance relationships between the adjacent markers and the non-adjacent markers.

2. The method according to claim 1 further comprising displaying the augmentation relative to a nearest visible marker at any point during operation of the application.

3. The method according to claim 2 wherein displaying the augmentation is a runtime step.

4. The method according to claim 1 wherein identifying a distance relationship between all of the other plurality of markers and the augmentation includes calculating an offset of the augmentation using an offset relative to the one marker modified by an offset of a currently visible marker to the one marker.

5. The method according to claim 4 wherein calculating the offset is an application runtime step.

6. The method according to claim 1 wherein determining a distance relationship between all non-adjacent markers includes multiplying select ones of the distance relationships between the two markers in all of the pairs of markers.

7. The method according to claim 1 wherein the workspace includes a robot.

8. The method according to claim 7 wherein the augmentation is a point on the robot.

9. The method according to claim 7 wherein the markers are located on a safety fence surrounding the workspace.

10. The method according to claim 1 wherein the AR device is a tablet, smartphone or AR glasses.

11. A method for providing an augmented reality (AR) application for calibrating a robot in a workspace, said method comprising:
placing a plurality of markers throughout the workspace so that a plurality of pairs of two adjacent markers can be viewed in a field-of-view of an AR device having a camera;
determining a distance relationship between the two adjacent markers in all of the pairs of markers;
determining a distance relationship between all pairs of non-adjacent markers using the distance relationship between the two markers in all of the pairs of markers including multiplying select ones of the distance relationships between the two markers in all of the pairs of markers;
identifying a distance relationship between one of the plurality of markers and a point on the robot;
identifying a distance relationship between all of the other plurality of markers and the point using the distance relationships between the adjacent markers and the non-adjacent markers; and
displaying the point relative to a nearest visible marker at any point during operation of the application.

12. The method according to claim 11 wherein identifying a distance relationship between all of the other plurality of markers and the point includes calculating an offset of the point using an offset relative to the one marker modified by an offset of a currently visible marker to the one marker.

13. The method according to claim 12 wherein calculating the offset is an application runtime step.

14. The method according to claim 11 wherein the markers are located on a safety fence surrounding the workspace.

15. A system for providing an augmented reality (AR) application, said system comprising:
means for placing a plurality of markers throughout a workspace so that a plurality of pairs of two adjacent markers can be viewed in a field-of-view of an AR device having a camera;
means for determining a distance relationship between the two adjacent markers in all of the pairs of markers;
means for determining a distance relationship between all pairs of non-adjacent markers using the distance relationship between the two markers in all of the pairs of markers;
means for identifying a distance relationship between one of the plurality of markers and an augmentation in the workspace; and
means for identifying a distance relationship between all of the other plurality of markers and the augmentation using the distance relationships between the adjacent markers and the non-adjacent markers.

16. The system according to claim 15 further comprising means for displaying the augmentation relative to a nearest visible marker at any point during operation of the application.

17. The system according to claim 15 wherein the means for identifying a distance relationship between all of the other plurality of markers and the augmentation calculates an offset of the augmentation using an offset relative to the one marker modified by an offset of a currently visible marker to the one marker.

18. The system according to claim 15 wherein the workspace includes a robot.

19. The system according to claim 18 wherein the augmentation is a point on the robot.

20. The system according to claim 18 wherein the markers are located on a safety fence surrounding the workspace.
